(19) United States
(12) Patent Application Publication
(10) Pub. No.: US 2011/0241257 A1
(43) Pub. Date: Oct. 6, 2011

(54) Multi-beam exposure scanning method and apparatus, and method for manufacturing printing plate

(75) Inventor: Ichirou Miyagawa, Kanagawa (JP)

(73) Assignee: Fujifilm Corporation, Minato-ku, Tokyo (JP)

(21) Appl. No.: 12/998,808

(22) PCT Filed: Dec. 3, 2009
(86) PCT No.: PCT/JP2009/070628

§ 371 Date: Jun. 3, 2011

(30) Foreign Application Priority Data
Dec. 5, 2008 (JP) 2008-311578

(51) Int. Cl. B29C 35/08

(52) U.S. Cl. 264/400; 425/174.4

(57) ABSTRACT

In a multi-beam exposure scanning method, when an irradiation region, which is a region on an object to be irradiated with a single beam, is exposed, the light quantity of the beam is controlled based on an exposed state of another irradiation region around the irradiation region to be exposed. When the other irradiation region near a periphery of the irradiation region to be exposed has not been exposed, the irradiation region is irradiated with a beam having a first light quantity. When the other irradiation region has been exposed, the irradiation region is irradiated with a beam having a second light quantity smaller than the first light quantity. Accordingly, influence of heat due to an adjacent beam can be effectively reduced.

### TECHNICAL FIELD

The present invention relates to a multi-beam exposure scanning method and apparatus. More particularly, the present invention relates to a multi-beam exposure scanning technique suitable for manufacture of a printing plate, such as a flexographic plate, and to a manufacturing technique of a printing plate, to which the multi-beam exposure scanning technique is applied.

### BACKGROUND ART

Conventionally, there has been disclosed a technique which engraves a recessed shape on the surface of a plate material by using a multi-beam head capable of simultaneously emitting a plurality of laser beams (Japanese Patent Application Laid-Open No. 09-85927). When a plate is engraved by such multi-beam exposure technique, it is very difficult to stably form fine shapes, such as small dots and thin lines, because of influence of heat due to adjacent beams.

In order to solve such problem, Japanese Patent Application Laid-Open No. 09-85927 proposes a configuration which performs so-called interlace exposure to reduce mutual thermal effects between adjacent beam spots in a beam spot array formed on the surface of a plate material. That is, Japanese Patent Application Laid-Open No. 09-85927 adopts a method in which a plurality of laser spots are formed on the surface of the plate material at an interval which is more than twice an engraving pitch corresponding to an engraving density to widen intervals between scanning lines formed in the first exposure scanning, and then scanning lines are formed by the second and subsequent scanning between the scanning lines formed in the first exposure scanning.

### CITATION LIST

### Patent Literature

PTL 1: Japanese Patent Application Laid-Open No. 09-85927

### SUMMARY OF INVENTION

### Technical Problem

However, in the method described in Japanese Patent Application Laid-Open No. 09-85927, in order to completely reduce the influence of the adjacent beam, the interval between the beam positions needs to be set sufficiently larger than the beam diameter on the surface of the plate material, and in practice, the interval between the scanning lines needs to be as large as several pixels (several lines). For this reason, the aberration of a lens used in an image forming optical system causes many practical limitations including difficulty in forming a beam array with precise scanning line intervals and complicated optical systems.

The present invention has been made in view of the above described circumstances. An object of the present invention is to provide a multi-beam exposure scanning method and apparatus, which are capable of effectively reducing the influence of heat generated by the adjacent beam in association with the multi-beam exposure, and which are capable of highly precisely forming a desired shape, such as a fine shape, and to provide a manufacturing method of a printing plate, to which the multi-beam exposure scanning method and apparatus are applied.

### Solution to Problem

In order to achieve the above described object, according to an aspect of the present invention, a multi-beam exposure scanning method for scanning an object with a plurality of light beams to engrave a surface of the object includes controlling a light quantity of a beam to be emitted to an irradiation region to be exposed is controlled based on an exposed state of another irradiation region around the irradiation region to be exposed. In other words, the multi-beam exposure scanning method includes: irradiating a first irradiation region to be exposed with a beam having a first light quantity when a second irradiation region near a periphery of the first irradiation region has not been exposed; and irradiating the first irradiation region to be exposed with a beam having a second light quantity smaller than the first light quantity when the second irradiation region has been exposed.

Note that an “irradiation region” means a region which is on an object (for example, recording medium), and to be irradiated with a single beam.

### Advantageous Effects of Invention

According to the aspect of the present invention, a desired shape can be highly precisely engraved in an object by optimizing a light quantity of an adjacent beam to be subsequently emitted in consideration of influence of heat due to a beam (or beams) previously emitted.

### BRIEF DESCRIPTION OF THE DRAWINGS

FIG. 1 is a configuration diagram of a plate making apparatus to which a multi-beam exposure scanning apparatus according to an embodiment of the present invention is applied;

FIG. 2 is a configuration diagram of an optical fiber array section arranged in an exposure head;

FIG. 3 is an enlarged view of the optical fiber array section;

FIG. 4 is a schematic diagram of an image forming optical system of the optical fiber array section;

FIG. 5 is an explanatory diagram illustrating an example of arrangement of optical fibers in the optical fiber array section and a relationship between the optical fibers and the scanning lines;

FIG. 6 is a plan view showing an outline of a scanning exposure system in the plate making apparatus according to the present embodiment;

FIG. 7 is a block diagram showing a configuration of a control system of the plate making apparatus according to the present embodiment;

FIG. 8 an explanatory diagram illustrating formation of thin lines along a sub-scanning direction;

FIG. 9 is a plan view of a thin line formed by a conventional exposure scanning method;

FIG. 10 is a graph showing an example of control of beam light quantity according the present embodiment;

FIG. 11 is a plan view of a thin line formed by the present embodiment;

FIG. 12 is a graph showing an example of light quantity control in the case of interlace exposure;

FIG. 13 is a schematic view showing a configuration example of an optical fiber array light source according to a second embodiment;

FIG. 14 an explanatory diagram illustrating formation of thin lines along the sub-scanning direction according to the second embodiment;

FIG. 15 is a graph showing an example of control of beam light quantity according the second embodiment; and

FIG. 16A an explanatory diagram illustrating an outline of a plate making process of a flexographic plate (No. 1).

FIG. 16B an explanatory diagram illustrating the outline of a plate making process of a flexographic plate (No. 2).

FIG. 16C an explanatory diagram illustrating the outline of a plate making process of a flexographic plate (No. 3).

### DESCRIPTION OF EMBODIMENTS

In the following, embodiments according to the present invention will be described in detail with reference to the accompanying drawings.

### <Configuration Example of Multi-Beam Exposure Scanning Apparatus>

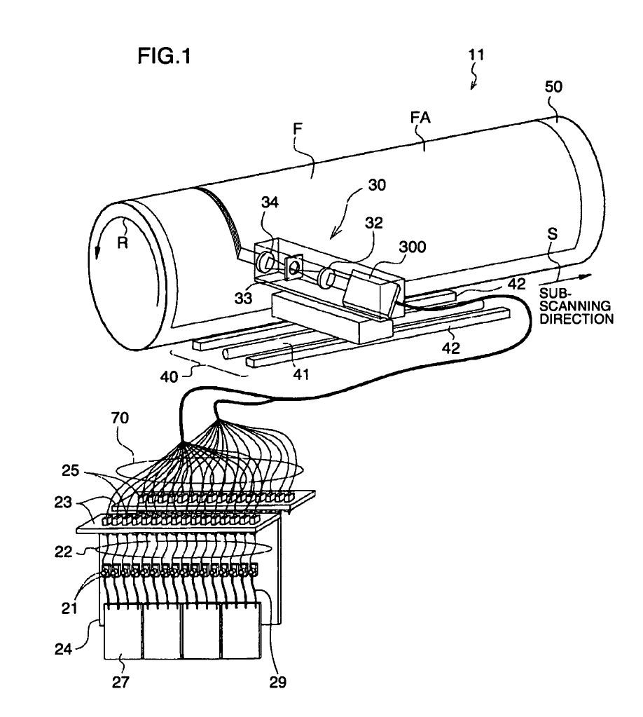

FIG. 1 shows a configuration of a plate making apparatus to which a multi-beam exposure scanning apparatus according to a first embodiment of the present invention is applied. In a plate making apparatus 11 shown in FIG. 1, a sheet-like plate material F is fixed on the outer peripheral surface of a drum 50 having a cylindrical shape, the drum 50 is rotated in the arrow R direction (main scanning direction) in FIG. 1, a plurality of laser beams corresponding to image data of the image to be engraved (recorded) in the plate material F are emitted from an exposure head 30 of a laser recording apparatus 10 toward the plate material F, and the exposure head 30 is scanned in the sub-scanning direction (the arrow S direction in FIG. 1) perpendicular to the main scanning direction at a predetermined pitch. Accordingly, the plate making apparatus 11 engraves (records) a two-dimensional image on the surface of the sheet-like an object to be engraved (or recording medium) (in FIG. 1, plate material F is shown as an example of the object) at high speed. Here, a case where a plate such as a rubber plate or a resin plate used for flexographic printing will be described as an example.

The laser recording apparatus 10 used in the plate making apparatus 11 according to the present embodiment includes: a light source unit 20 which generates a plurality of laser beams; the exposure head 30 which irradiates the plate material F with the plurality of laser beams generated by the light source unit 20; and an exposure head movement section 40 which moves the exposure head 30 along the sub-scanning direction.

The light source unit 20 includes a plurality of semiconductor lasers 21 (here, for example, a total of 32 semiconductor lasers), and the light beams of the respective semiconductor lasers 21 are individually transmitted to an optical fiber array section 300 of the exposure head 30 via optical fibers 22 and 70, respectively.

In the present embodiment, a broad area semiconductor laser (wavelength: 915 nm, for example) is used as the semiconductor laser 21, and the semiconductor lasers 21 are arranged side by side on a light source substrate 24. Each of the semiconductor lasers 21 is individually coupled to one end section of each of the optical fibers 22, and the other end of each of the optical fibers 22 is connected to an adapter of an SC (Single Core) type optical connector 25.

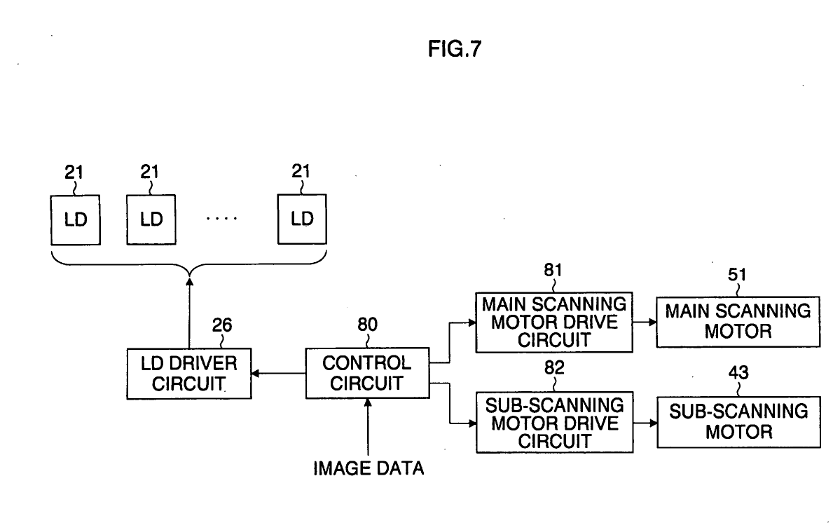

An adapter substrate 23 for supporting the SC type optical connectors 25 is perpendicularly attached to one end section of the light source substrate 24. Further, to the other end section of the light source substrate 24, there are attached LD (Laser Diode) driver substrates 27 on which an LD driver circuit (not shown in FIG. 1, and denoted by reference numeral 26 in FIG. 7) for driving the semiconductor lasers 21 is mounted. Each of the semiconductor lasers 21 is connected to the corresponding LD driver circuit via each individual wiring member 29, so that each of the semiconductor lasers 21 is individually driven and controlled.

Note that in the present embodiment, a multi-mode optical fiber having a relatively large core diameter is applied as the optical fiber 70 in order to increase the output of the laser beam. Specifically, an optical fiber having a core diameter of 105 μm is used in the present embodiment. Further, a semiconductor laser having a maximum output of about 10 W is used as the semiconductor laser 21. Specifically, it is possible to adopt, for example, a semiconductor laser (6398-L4 Series) which is marketed by JDS Uniphase Corporation and which has a core diameter of 105 μm and an output of 10 W, or the like.

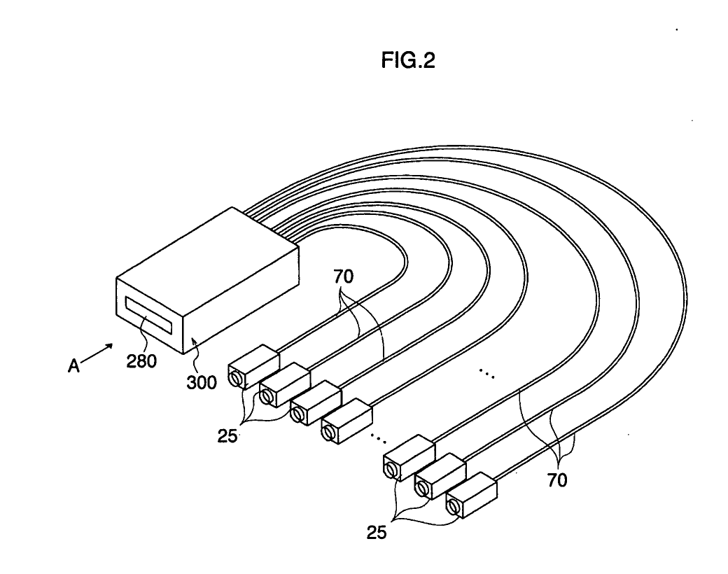

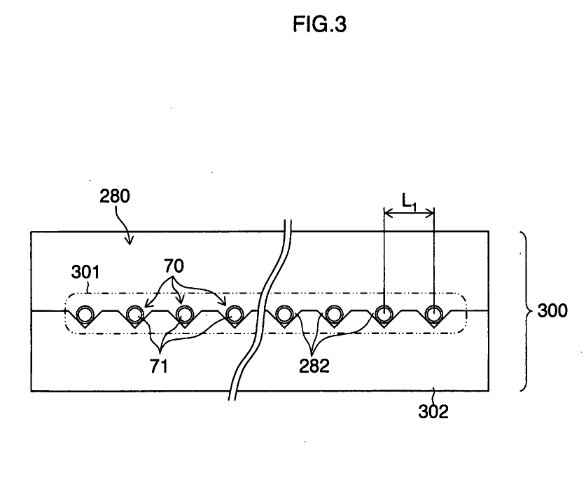

On the other hand, the exposure head 30 includes an optical fiber array section 300 which collects the respective laser beams emitted from the plurality of semiconductor lasers 21 and emits the collected laser beams. The light emitting section (not shown in FIG. 1 and denoted by reference numeral 280 in FIG. 2) of the optical fiber array section 300 has a configuration in which the emitting ends of the 32 optical fibers 70, 70, . . . led from the respective semiconductor lasers 21, 21, . . . are arranged in a row (see FIG. 3).

Further, in the exposure head 30, a collimator lens 32, an opening member 33, and an image forming lens 34 are provided side by side in this order from the side of the light emitting section of the optical fiber array section 300. An image forming optical system is configured by combining the collimator lens 32 and the image forming lens 34. The opening member 33 is arranged in a manner that its opening is positioned at a Far Field position when seen from the side of the optical fiber array section 300. Thereby, the same light quantity restricting effect can be given to all the laser beams emitted from the optical fiber array section 300.

The exposure head movement section 40 includes a ball screw 41 and two rails 42, whose longitudinal direction is arranged along the sub-scanning direction. Thus, when a sub-scanning motor (not shown in FIG. 1 and denoted by reference numeral 43 in FIG. 7) for driving and rotating the ball screw 41 is operated, the exposure head 30 arranged on the ball screw 41 can be moved in the sub-scanning direction in the state of being guided by the rails 42. Further, when a main scanning motor (not shown in FIG. 1 and denoted by reference numeral 51 in FIG. 7) is operated, the drum 50 can be rotated in a direction (arrow R direction) indicated by the arrow R in FIG. 1, and thereby the main scanning is performed.

FIG. 2 shows a configuration of the optical fiber array section 300, and FIG. 3 is an enlarged view (view A in FIG. 2) of the light emitting section 280 of the optical fiber array section 300. As shown in FIG. 3, the light emitting section 280 of the optical fiber array section 300 has the optical fibers 70 having a core diameter of 105 μm which emit 32 light beams at equal intervals, and are linearly arranged side by side in a row.

The optical fiber array section 300 has a base (V-groove substrate) 302, in one surface of which the same number of V-shaped grooves as the semiconductor lasers 21, that is, 32 V-shaped grooves are formed so as to be adjacent to each other at predetermined intervals. An optical fiber end section 71 as the other end section of each of the optical fibers 70 is fitted into each of the V-shaped grooves of the base 302. Thereby, a group 301 of the optical fiber end sections linearly arranged side by side is formed. Therefore, a plurality of laser beams, in this example, 32 laser beams, are simultaneously emitted from the light emitting section 280 of the optical fiber array section 300.

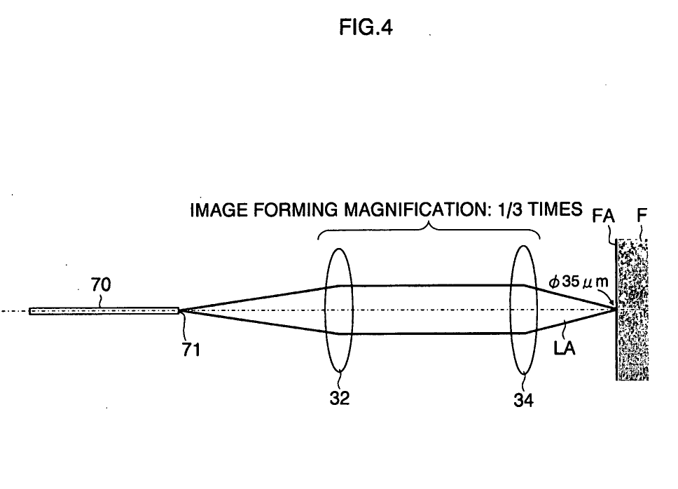

FIG. 4 is a schematic diagram of the image forming system of the optical fiber array section 300. As shown in FIG. 4, an image of the light emitting section 280 of the optical fiber array section 300 is formed in the vicinity of the exposure surface (surface) FA of the plate material F at a predetermined magnification (image forming magnification) by the image forming device including the collimator lens 32 and the image forming lens 34. In the present embodiment, the image forming magnification is set to ⅓ times. Thereby, the spot diameters of laser beams LA emitted from the optical fiber end sections 71 respectively having the core diameter of 105 μm are set to be φ35 μm.

In the exposure head 30 having such image forming system, an interval P1 between scanning lines (main scanning lines) K exposed by the laser beams emitted from the optical fibers arranged at adjacent positions as shown in FIG. 5 can be set to 10.58 (corresponding to a resolution of 2400 dpi in the sub-scanning direction) by suitably designing the interval (L1 in FIG. 3) between the adjacent fibers of the optical fiber array section 300 described with reference to FIG. 3, and the inclination angle (angle θ in FIG. 5) in the arrangement direction (array direction) of the optical fiber end section group 301 at the time of fixing the optical fiber array section 300.

This arrangement enables the exposure head 30 to scan and expose a range of 32 lines (one swath) at a time.

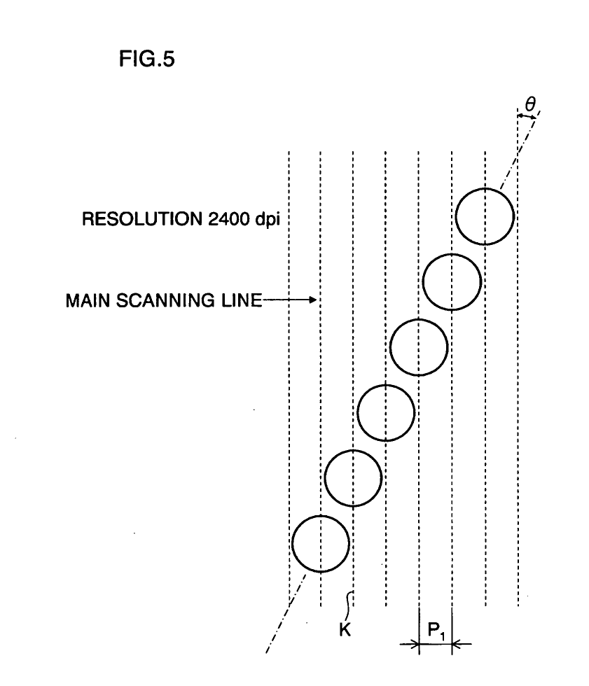

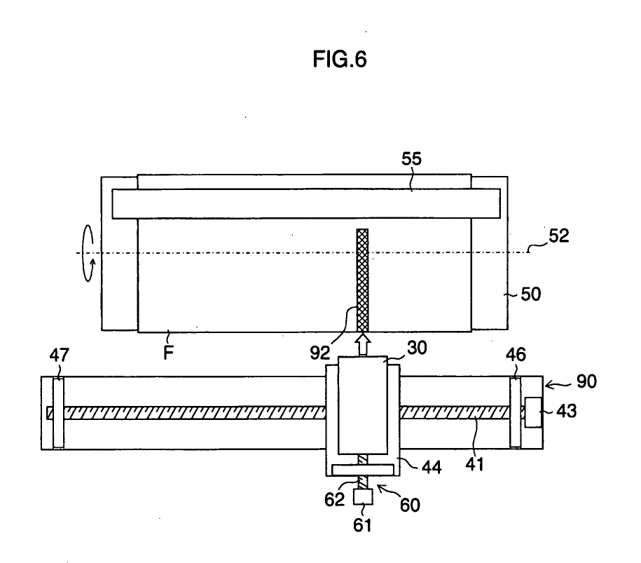

FIG. 6 is a plan view showing an outline of a scanning exposure system in the plate making apparatus 11 shown in FIG. 1. The exposure head 30 includes a focus position changing mechanism 60 and an intermittent feeding mechanism 90 which performs feeding in the sub-scanning direction.

The focus position changing mechanism 60 has a motor 61 and a ball screw 62, which move the exposure head 30 back and forth with respect to the surface of the drum 50, and is capable of moving the focus position by about 300 μm for about 0.1 second by the control of the motor 61. The intermittent feeding mechanism 90 configures the exposure head movement section 40 described with reference to FIG. 1, and has the ball screw 41 and the sub-scanning motor 43 for rotating the ball screw 41 as shown in FIG. 6. The exposure head 30 is fixed to a stage 44 on the ball screw 41, and can be intermittently fed by the control of the sub-scanning motor 43 in the axial line 52 direction of the drum 50 at a rate which enables to travel one swath for about 0.1 second to reach an adjacent swath.

Note that in FIG. 6, reference numerals 46 and 47 denote bearings rotatably supporting the ball screw 41. Reference numeral 55 denotes a chuck member for chucking the plate material F on the drum 50. The position of the chuck member 55 is set in a non-recording region where exposure (recording) is not performed by the exposure head 30. While the drum is rotated, the laser beams of 32 channels are emitted from the exposure head 30 onto the plate material F on the rotating drum 50. Thereby, an exposure range 92 corresponding to the 32 channels (one swath) is exposed without gaps, and the surface of the plate material F is engraved (image recorded) by one swath width. When the chuck member 55 is then made to pass through the front of the exposure head 30 by the rotation of the drum 50 (in the non-recording region of the plate material F), the exposure head 30 is intermittently fed in the sub-scanning direction, and then a next one swath is exposed. A desired image is formed on the whole surface of the plate material F by repeating the exposure and scanning associated with the above described intermittent feeding in the sub-scanning direction.

In the present embodiment, the sheet-like plate material F is used, but a cylindrical object (sleeve type) can also be used.

### <Configuration of Control System>

FIG. 7 is a block diagram showing a configuration of a control system of the plate making apparatus 11. As shown in FIG. 7, the plate making apparatus 11 includes: the LD driver circuit 26 which drives the respective semiconductor lasers 21 according to two-dimensional image data to be engraved; the main scanning motor 51 which rotates the drum 50; a main scanning motor drive circuit 81 which drives the main scanning motor 51; a sub-scanning motor drive circuit 82 which drives the sub-scanning motor 43; and a control circuit 80. The control circuit 80 controls the LD driver circuit 26 and each of the motor drive circuits (81, 82).

Image data representing an image to be engraved (recorded) in the plate material F are supplied to the control circuit 80. On the basis of the image data, the control circuit 80 controls the drive of the main scanning motor 51 and the sub-scanning motor 43, and individually controls the output (performs the on/off control and the laser beam power control) of each of the semiconductor lasers 21. Note that means to control the output of the laser beam is not limited to a mode utilizing the quantity of light emitted from the semiconductor lasers 21. In place of the mode, or in combination with the mode, optical modulation device such as an acoustic optical modulator (AOM) module may also be used.

### <Description of Problem>

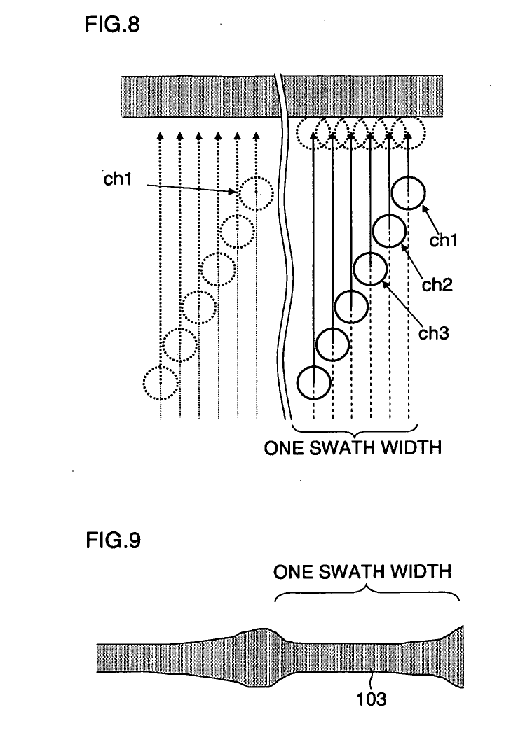

There will be described as an example a case where thin lines are engraved on the plate material F (object) along the sub-scanning direction by the multi-beam group arranged in the array arrangement described with reference to FIG. 3. As shown in FIG. 8, the channel ch1 (first beam) at the right end first emits light to perform engraving. Next, the left-adjacent channel ch2 (second beam) emits light to perform engraving, and subsequently, the channels ch3 to ch32 (beams) adjacent to each other successively emit light, so that the engraving is performed by one swath width. After the engraving by one swath width is completed, the exposure head 30 is moved by the swath width in the sub-scanning direction, and the engraving is successively performed. Thereby, the thin lines along the sub-scanning direction are formed.

When the light quantities of the respective channels ch1 to ch32 are set equal to each other, and when the thin line 103 obtained by the above described process is observed in detail, it is seen that the width of the thin line 103 is varied at the frequency of one swath width as shown in FIG. 9. It is found that this phenomenon is caused by the following factors.

That is, when attention is directed to within the swath width, the engraving is first performed by a first beam, and the plate material is warmed by the residual heat caused by the irradiation of the first beam. The engraving is performed there by emitting a second beam for engraving the subsequent adjacent line, and hence the energy of the second beam is further added to the plate material F whose temperature is increased by the influence of the residual heat due to the engraving by the first beam. Thus, it is found that there is a problem that the subsequent beam excessively engraves the plate material F under the influence of heat due to the engraving performed by the precedent adjacent beam.

### <Means for Solving the Problem>

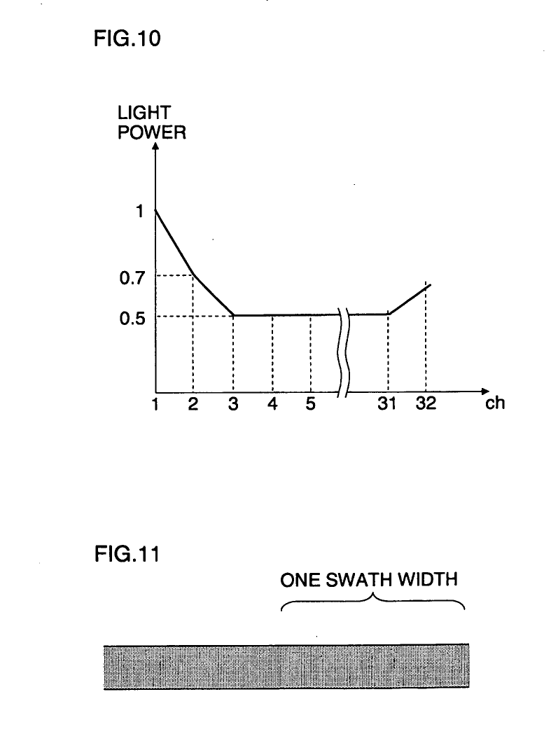

In the plate making apparatus 11 according to the present embodiment, the light powers of the beams are controlled by each channel in order to solve the above described problem. An example of the control is shown in FIG. 10. In FIG. 10, the abscissa represents the channel identification number (ch), and the ordinate represents the relative value of the light power of the beam (the power of ch1 is normalized to 1). As shown in FIG. 10, the light power of channels ch1, ch2, and ch3 corresponding to the writing start portion at which the engraving is started is set as expressed by ch1>ch2>ch3, and the light powers of ch3 and the channels subsequent to ch3 (intermediate sections) can be substantially set to be the same as each other. Further, the light power of the last channel (ch32) (writing end portion) within the swath is increased (for example, ch32=ch2).

As described with reference to FIG. 8, when thin lines along the sub-scanning direction are formed by the beam arrangement of the obliquely arranged channel group, a time difference is caused in the light emission timing (pixel exposure timing) between the respective channels. The beam of ch1 is first emitted, and while the beam of ch1 is scanned for exposure, the subsequent beam of ch2 is then emitted. At this time, the surface temperature of the plate material F corresponding to the beam position of ch2 is increased by the influence of heat due to the preceding beam of ch1. Thus, the light power of ch2 is reduced than that of ch1 in consideration of the influence of heat due to the adjacent beam.

In FIG. 10, the light power of ch2 is set to 0.7 with respect to the light power of ch1 (which is normalized to 1), but the light quantity ratio of the beam adjacent to the beam to be first scanned with respect to the beam to be first scanned is suitably set in the range of 0.4 to 0.9.

Similarly, the light power of ch3 is also further reduced than that of ch2 in consideration of the accumulation of heat due to the beams of ch1 and ch2 (for example, set to 0.5 in FIG. 10).

However, the heat condition is substantially saturated in ch3 and channels subsequent to ch3, and hence the light powers of these channels are substantially the same as each other in the intermediate portion of one line. Thereby, a thin line along the sub-scanning direction can be formed in a linear state having a substantially constant (uniform) line width.

Note that FIG. 10 shows only an example of the case where the spot diameter of the beam is set to φ35 μm, and where the resolution is set to 2400 dpi (scanning line interval=10.6 μm), and that it is necessary to optimize light powers of respective channels on the basis of the conditions of the spot diameter, the spot arrangement, the scanning speed, the plate material, and the like. For example, depending on the conditions, the relation of the light power between the beams may set as represented by ch1≧ch2≈ch3≈ch4 . . . , or may also be set as represented by ch1>ch2>ch3>ch4 (≈ch5≈ch6 . . . ).

It is effective to perform such light power control in the range of several pixels (about two to four pixels) in the writing start portion, and it is effective to perform the light power control for each beam for at least the two adjacent pixels (ch1 and ch2).

Further, the condition of the last channel (here ch32) is different from the conditions of the other intermediate channels (ch4 to ch31) in that the last channel is not subjected to the influence of heat due to the subsequent beam. Thus, the light power of the last channel may be increased, or may be set to the same light power as that in the adjacent preceding channel (ch31) depending on conditions.

As exemplified in the above described embodiment, in the case where a desired shape is formed by engraving the vicinity of the surface of an object (plate material F) by laser beams of a multi-beam exposure system, the light quantity of the current laser beam to be emitted is controlled on the basis of the light emission state of a region to be irradiated with another laser beam, which is around the pixel A (irradiation region) to be irradiated by the current laser beam to be emitted. Specifically, in the light control, light quantities are controlled to satisfy the equation of “a>b.” Here, “a” indicates the light quantity of the current beam (first beam) to be emitted in the case that a region located within several pixels around an irradiation region (pixel A) of the current beam in the sub-scanning direction has been irradiated with the other beams. And, “b” indicates the light quantity of another beam (second beam) adjacent to the current beam (first beam) in the case that a region (pixel B) adjacent to the pixel A is irradiated with the second beam at some time interval after the pixel A has been irradiated by the current beam (first beam).

### <In the Case of Interlace Exposure>

With reference to FIG. 10, there is described the case where the non-interlace exposure for exposing all pixels in one swath at once is performed without spaces between pixels at the time of exposure and scanning, but the present embodiment can also be similarly applied to the case of the interlace exposure in which the pixels are exposed alternately in the sub-scanning direction.

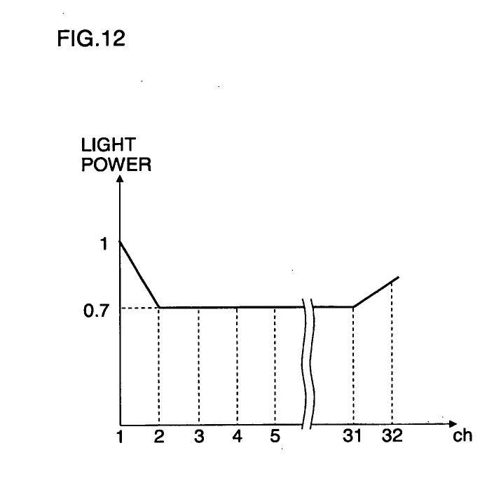

FIG. 12 shows an example of the light power control between the channels in the case of performing the interlace exposure in which the pixels are exposed alternately in the sub-scanning direction under the conditions of the spot diameter of φ35 μm and the resolution of 2400 dpi (the scanning line interval=10.6 μm).

The exposure process is influenced by the heat due to the adjacent beam also in the interlace exposure, and hence the light power of ch2 is reduced than that of ch1 (normalized to 1). The light power of ch2 is set to “0.7” in FIG. 12, but the present embodiment is not limited to this. The light quantity ratio of the beam adjacent to the preceding beam with respect to the preceding beam is suitably set in the range of 0.5 to 0.9.

Note that in the case of the interlace exposure, the beam density is low (coarse) as compared with the non-interlace exposure, and the time interval from when the beam of ch1 is emitted to when the beam of ch2 is emitted is long as compared with the non-interlace exposure. Thus, the influence of the heat between adjacent beams becomes smaller than the case of the non-interlace exposure. For this reason, the reduction amount of the light power of ch2 and the channels subsequent to ch2 in the interlace exposure (FIG. 12) is reduced as compared with the case of the non-interlace exposure (FIG. 10).

### Second Embodiment

The above described first embodiment exemplifies the beam arrangement in which beams of 32 lines (one swath) are arranged obliquely in one row by using the exposure head 30 having the optical fiber array arrangement in one row as described with reference to FIG. 3. However, the beam arrangement is not limited to such one row arrangement when carrying out the present invention.

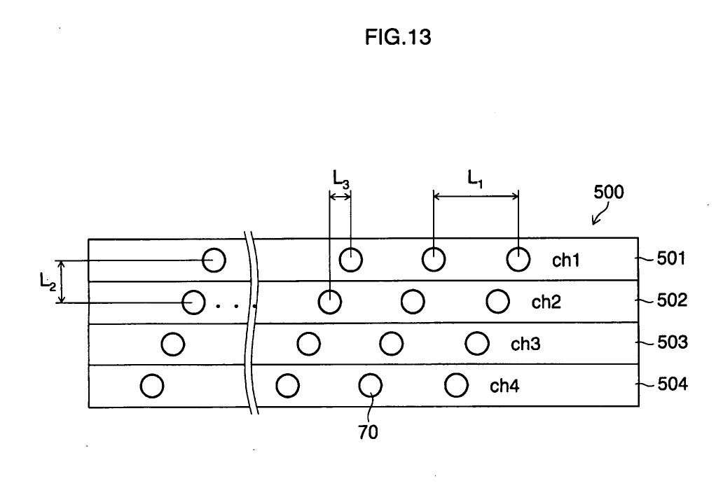

FIG. 13 shows an example of another optical fiber array unit light source. The optical fiber array unit light source 500 shown in FIG. 13 includes optical fiber array units 501, 502, 503 and 504 combined in four stages. In each array of the stages of the optical fiber array unit light source 500, 16 pieces of the optical fibers 70 having a core diameter of 105 μm are linearly arranged in one row, and 64 pieces of the optical fibers 70, in total, of the four stages are arranged in an oblique matrix shape.

As shown in FIG. 13, in the case where channel identification numbers for the channels belonging to the optical fiber array unit 501 of the uppermost stage (first stage) are set as 4M+1 (M=0, 1, 2 . . . ) from the right end, where channel identification numbers for the channels belonging to the second stage (reference numeral 502) are set as 4M+2 from the right end, where channel identification numbers for the channels belonging to the third stage (reference numeral 503) are set as 4M+3 from the right end, and where channel identification numbers for the channels belonging to the lowermost fourth stage (reference numeral 503) are set as 4M+4 from the right end, the optical fiber array unit light source 500 is configured such that blocks respectively consisting of four channels having a common M value are arranged in 16 rows.

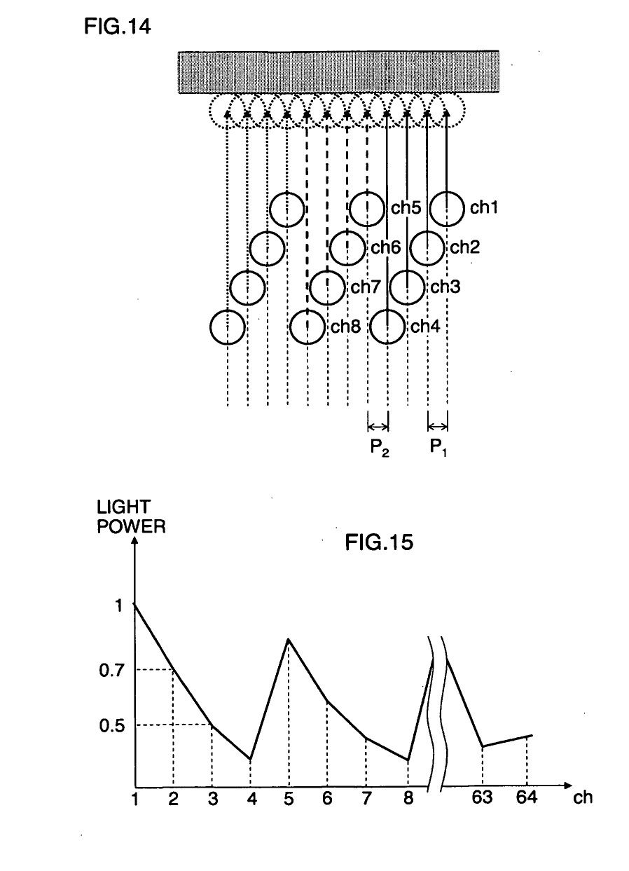

When the interval (L₁ in FIG. 13) between the adjacent optical fibers in the row of the optical fiber array units 501, 502, 503 and 504 of the respective stages, the interval between the optical fibers of the respective adjacent stages (L₂), and the relative positional difference between the adjacent optical fibers in the row direction (L₃ in FIG. 13), and further the inclination angle of the array unit are suitably designed, the interval P₁ between the scanning lines (main scanning lines) K exposed by the optical fibers of the adjacent channels within the block, and the interval P₂ between a scanning line exposed by a channel at a right end of the block consisting of the four channels (the channel belonging to the array of the uppermost stage) and a scanning line exposed by a channel at a left end of the adjacent block (the channel belonging to the array of the lowermost stage) can be equally set to 10.58 μm (corresponding to the resolution 2400 dpi in the sub-scanning direction) as shown in FIG. 14.

According to the above described configuration, one swath including 64 lines in total can be scanned and exposed by using four lines as a repeating unit.

When thin lines along the sub-scanning direction are engraved by such beam arrangement, the light power of each beam channel is controlled, for example, as shown in FIG. 15.

In FIG. 15, the abscissa represents the channel identification number, and the ordinate represents the light power (when the light power of ch1 is normalized to 1). As shown in FIG. 15, in correspondence with the repetition of the swath block of the four line unit, the light powers of the respective channels in the repeating unit are set to satisfy the following in equation: ch(4M+1)>ch(4M+2)>ch(4M+3)>ch(4M+4).

Thereby, the thin line along the sub-scanning direction can be formed in a linear state having a substantially constant (uniform) line width as described with reference to FIG. 11. Note that the above description is given by taking the thin line along the sub-scanning direction as an example, but the present embodiment is not limited to this. For example, the present embodiment can be similarly applied to the case where thin lines along an oblique direction are formed.

Further, the form of the optical fiber array unit light source is not limited to the example described with reference to FIG. 13. An arbitrary number of array stages and an arbitrary repetition number of the swath blocks can be realized by the same method as described with reference to FIG. 13, and a suitable two-dimensional array can be realized.

### <Modification>

The exposure system is not limited to the scanning exposure system based on the intermittent feeding in the sub-scanning direction as described with reference to FIG. 6, and there may also be applied to a spiral exposure system which scans the surface of the plate material F in a spiral pattern by moving the exposure head 30 with a constant speed in the sub-scanning direction while the drum is rotated.

The intermittent feeding system is effective in the case where the rotation speed of the drum is relatively low. On the other hand, the spiral exposure system is effective in the case where the rotation speed of the drum is relatively high.

### <Manufacturing Process of Flexographic Plate>

Next, there will be described an exposure scanning process at the time of manufacturing a printing plate by the multi-beam exposure system.

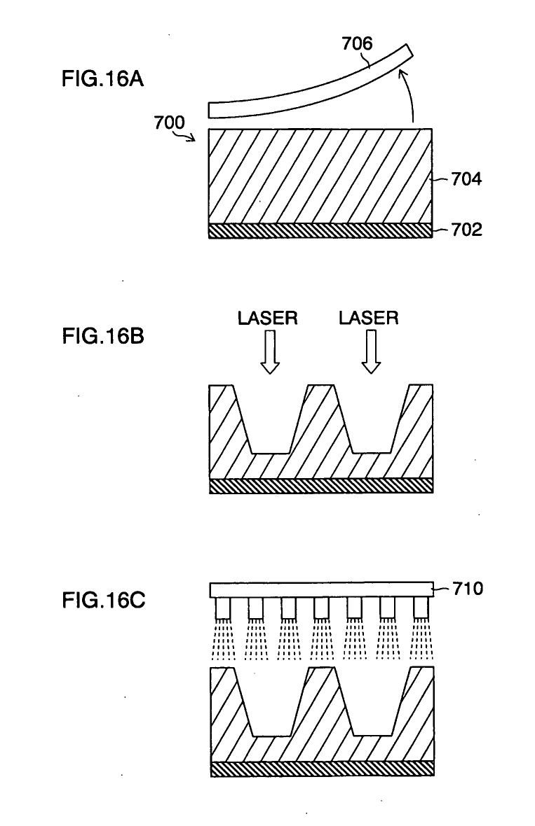

FIGS. 16A to 16C show an outline of a plate making process. A raw plate 700 used for platemaking by the laser engraving has an engraving layer 704 (including a rubber layer or a resin layer) on a substrate 702, and has a protection cover film 706 which is stuck on the engraving layer 704. At the time of platemaking processing, as shown in FIG. 16A, the cover film 706 is peeled off to expose the engraving layer 704. Then, a part of the engraving layer 704 is removed by irradiating the engraving layer 704 with laser light beams to form a desired three-dimensional shape (see FIG. 16B). The specific laser engraving method has been described with reference to FIGS. 1 to 15. Note that dust generated during the laser engraving is sucked and recovered by a suction apparatus (not shown).

After the engraving process is completed, the plate 700 is washed with water by a washing apparatus 710 as shown in FIG. 16C (washing process), and then dried (not shown) to obtain a flexographic plate.

The platemaking method, by which a plate itself is directly engraved with a laser beam in this way, is referred to as a direct engraving method. A plate making apparatus, to which the multi-beam exposure scanning apparatus according to the present embodiment is applied, can be realized at a lower cost than a laser engraving machine using a CO₂ laser. Further, processing speed can be improved by using the multi-beam exposure system, and thus the productivity of the printing plate can be improved.

### <Other Applications>

The present invention is not limited to manufacture of flexographic plates, and the present invention can also be applied to manufacture of the other convex printing plates or concave printing plates. Further, the present invention is not limited to manufacture of printing plates, and the present invention can also be applied to a drawing recording apparatus and an engraving apparatus for various applications.

### APPENDIX

As grasped from the description about the embodiments described above in detail, this specification includes disclosure of various technical ideas including the invention as will be described below.

(Invention 1): A multi-beam exposure scanning method for scanning an object with a plurality of light beams to engrave a surface of the object, comprising: irradiating a first irradiation region to be exposed with a beam having a first light quantity when a second irradiation region near a periphery of the first irradiation region has not been exposed; and irradiating the first irradiation region to be exposed with a beam having a second light quantity smaller than the first light quantity when the second irradiation region has been exposed.

Accordingly, since the light quantity of the beam can be suitably controlled in consideration of the influence of heat due to adjacent beams emitted at some time interval (with a time difference), it is possible to suppress unevenness in an engraved shape caused by thermal interference due to the adjacent beams, thereby enabling to highly precisely engrave a desired shape in the object.

(Invention 2): The multi-beam exposure scanning method according to invention 1, wherein: the second irradiation region is adjacent to the first irradiation region; the first irradiation region is irradiated with a first beam having the first light quantity when a third irradiation region which is adjacent to the first irradiation region has not been exposed; and the second irradiation region is irradiated with a second beam having the second light quantity when the second irradiation region is irradiated after a lapse of a predetermined period of time from the exposure of the first irradiation region.

This mode enables to form uniform shape on the first irradiation region and the second irradiation region adjacent to the first irradiation region.

(Invention 3): The multi-beam exposure scanning method according to invention 2, wherein the second light quantity is set within the range of 0.4 to 0.9 times as much as the first light quantity.

It is preferable that the light quantity ratio of the beam subsequent to the preceding beam with respect to the preceding beam is set in the range of 0.4 to 0.9 in a system employing non-interlace exposure, and that the light quantity ratio of the subsequent beam with respect to the preceding beam is set in the range of 0.5 to 0.9 in a system employing interlace exposure.

(Invention 4): The multi-beam exposure scanning method according to one of invention 2 and invention 3, further comprising irradiating a fourth irradiation region adjacent to the second irradiation region with a third beam having a third light quantity equal to or smaller than the second light quantity.

Depending on conditions, it is also possible to control beam light quantities of beams which are used to irradiate three continuously arranged irradiation regions to obtain a uniformly engraved shape.

(Invention 5): The multi-beam exposure scanning method according to any one of invention 2 to invention 4, further comprising successively irradiating a row of irradiation regions adjacent to each other from a fourth irradiation region adjacent to the second irradiation region, with respective beams whose light quantities are substantially identical.

It is preferable that the light quantities of the beams used for exposing irradiation regions where influence of heat due to beams previously irradiated are substantially the same are set to be substantially the same as each other.

(Invention 6): A multi-beam exposure scanning apparatus comprising: an exposure head which irradiates a surface of an object by with a plurality of light beams to engrave the object; a scanning device which performs relative movement of the object and the exposure head; and a control device which controls light quantity of a light beam, wherein the control device sets a beam used for irradiating a first irradiation region to have a first light quantity when a second irradiation region near a periphery of the first irradiation region has not been exposed, and the control device sets the beam to have a second light quantity smaller than the first light quantity when the second irradiation region has been exposed.

Accordingly, since the beam light quantity is suitably controlled in consideration of influence of heat due to adjacent beams irradiated at some time interval (with a time difference), it is possible to suppress excessive engraving due to thermal interference caused by the adjacent beams, thereby enabling to highly precisely engrave a desired shape in the object.

(Invention 7): The multi-beam exposure scanning apparatus according to invention 6, wherein: the second irradiation region is adjacent to the first irradiation region; the control device sets a first beam used for irradiating the first irradiation region to have the first light quantity when a third irradiation region which is adjacent to the first irradiation region has not been exposed; and the control device sets a second beam to have the second light quantity when the second irradiation region is irradiated after a lapse of a predetermined period of time from the exposure of the first irradiation region.

(Invention 8): The multi-beam exposure scanning apparatus according to invention 7, wherein the second light quantity is set in the range of 0.4 to 0.9 times as much as the first light quantity.

(Invention 9): The multi-beam exposure scanning apparatus according to one of invention 7 and invention 8, wherein the control device controls a third beam used for irradiating a fourth irradiation region adjacent to the second irradiation region to have a third light quantity equal to or smaller than the second light quantity.

(Invention 10): The multi-beam exposure scanning apparatus according to any one of invention 7 to invention 9, wherein the control device controls respective beams used for irradiating irradiation regions to have a substantially identical light amount when the irradiation regions are successively exposed from a fourth irradiation region.

(Invention 11): The multi-beam exposure scanning apparatus according to any one of invention 6 to invention 10, wherein the scanning device includes: a drum which rotates with the object held on an outer peripheral surface of the drum; and a head moving device which moves the exposure head along an axial direction of the drum.

It is possible to configure the multi-beam exposure scanning apparatus such that the scanning in the main scanning direction is performed by rotation of the drum, and that the scanning in the sub-scanning direction is performed by the movement of the exposure head in an axial direction of the drum.

(Invention 12): The multi-beam exposure scanning apparatus according to any one of invention 6 to invention 11, wherein the exposure head comprises an optical fiber array which has a beam arrangement in which beams of a plurality of channels are arranged along a direction oblique to a sub-scanning direction on the object.

(Invention 13): The multi-beam exposure scanning apparatus according to invention 12, wherein the control device controls a first channel located at an endmost beam position where exposure is first started within one swath in the beam arrangement to have the first light quantity, and a second channel adjacent to the first channel to have the second light quantity.

(Invention 14): A manufacturing method of a printing plate, comprising engraving a surface of a plate material corresponding to the object by the multi-beam exposure scanning method according to any one of invention 1 to invention 5 to manufacture the printing plate.

According to the embodiments of the present invention, a printing plate can be manufactured at high speed and with high precision. Therefore, the productivity can be improved and a cost reduction can be realized.

### REFERENCE SIGNS LIST

10 . . . Laser recording apparatus, 11 . . . Plate making apparatus, 20 . . . Light source unit, 21 . . . Semiconductor laser, 22, 70 . . . Optical fiber, 30 . . . Exposure head, 40 . . . Exposure head movement section, 50 . . . Drum, 80 . . . Control circuit, 300 . . . Optical fiber array section, F . . . Plate material, K . . . Scanning line

1. A multi-beam exposure scanning method for scanning a flexographic plate with a plurality of light beams emitted from fiber-coupled laser diodes to engrave a surface of the flexographic plate, comprising
controlling light quantities of the plurality of beams which respectively successively expose a plurality of irradiation regions according to exposed states of other irradiation regions,
wherein the controlling of the light quantities of the plurality of beams includes:
setting a light amount of a front-end beam which primarily scans among the plurality of beams, to a first light quantity when an adjacent region adjacent to an irradiation region of the front-end beam has not been exposed, and setting the light amount of the front-end beam to a second light quantity smaller than the first light quantity when the adjacent region has been exposed;
setting light quantities of two or more beams of the plurality of beams, the two or more beams adjacent to the front-end beam and subsequently scanning after the scanning of the front-end beam, to be gradually smaller than the light quantity of the front-end beam; and
setting a light amount of a rear-end beam which lastly scans among the plurality of beams, to be larger than a light quantity of a beam adjacent to the rear-end beam.

2. The multi-beam exposure scanning method according to claim 1, wherein:
the controlling of the light quantities of the plurality of beams includes
determining the light quantities of the plurality of beams according to a lapse of a predetermined period of time from the scanning of preceding beams.

3. The multi-beam exposure scanning method according to claim 1,
wherein the light quantities of the two or more beams are set within the range of 0.4 to 0.9 times as much as the light quantity of the front-end beam.

4. (canceled)

5. The multi-beam exposure scanning method according to claim 1 wherein
the light quantities of beams which are third adjacent beam of the front-end beam or more are substantially identical.

6. A multi-beam exposure scanning apparatus comprising:
fiber-coupled laser diodes which emit a plurality of beams to a surface of a flexographic plate engrave the flexographic plate;
a scanning device which performs relative movement of the flexographic plate and the fiber-coupled laser diodes; and
a control device which controls light quantities of the light beams,
wherein the control device sets a light amount of a front-end beam which primarily scans among the plurality of beams, to a first light quantity when an adjacent region adjacent to an irradiation region of the front-end beam has not been exposed, and setting the light amount of the front-end beam to a second light quantity smaller than the first light quantity when the adjacent region has been exposed;
sets light quantities of two or more beams of the plurality of beams, the two or more beams adjacent to the front-end beam and subsequently scanning after the scanning of the front-end beam, to be gradually smaller than the light quantity of the front-end beam; and
sets a light amount of a rear-end beam which lastly scans among the plurality of beams, to be larger than a light quantity of a beam adjacent to the rear-end beam.

7. The multi-beam exposure scanning apparatus according to claim 6, wherein:
the control device sets the light quantities of the plurality of beams according to a lapse of a predetermined period of time from the scanning of preceding beams.

8. The multi-beam exposure scanning apparatus according to claim 6, wherein
the light quantities of the two or more beams are set in the range of 0.4 to 0.9 times as much as the light quantity of the front-end beam.

9. (canceled)

10. The multi-beam exposure scanning apparatus according to claim 6,
wherein the control device controls respective beams which are third adjacent beam of the front-end beam or more to have a substantially identical light amount.

11. The multi-beam exposure scanning apparatus according to claim 6,
wherein the scanning device includes:
a drum which rotates with the flexographic plate held on an outer peripheral surface of the drum; and
a moving device which moves the fiber-coupled laser diodes along an axial direction of the drum.

12. The multi-beam exposure scanning apparatus according to claim 6,
wherein the fiber-coupled laser diodes comprises an optical fiber array which has a beam arrangement in which beams of a plurality of channels are arranged along a direction oblique to a sub-scanning direction on the flexographic plate.

13. (canceled)

14. A manufacturing method of a printing plate, comprising engraving a surface of a plate material corresponding to the flexographic plate by a multi-beam exposure scanning method for scanning a flexographic plate with a plurality of light beams emitted from fiber-coupled laser diodes to engrave a surface of the flexographic plate, comprising
controlling light quantities of the plurality of beams which respectively successively expose a plurality of irradiation regions according to exposed states of other irradiation regions,
wherein the controlling of the light quantities of the plurality of beams includes:
setting a light amount of a front-end beam which primarily scans among the plurality of beams, to a first light quantity when an adjacent region adjacent to an irradiation region of the front-end beam has not been exposed, and setting the light amount of the front-end beam to a second light quantity smaller than the first light quantity when the adjacent region has been exposed;
setting light quantities of two or more beams of the plurality of beams, the two or more beams adjacent to the front-end beam and subsequently scanning after the scanning of the front-end beam, to be gradually smaller than the light quantity of the front-end beam; and
setting a light amount of a rear-end beam which lastly scans among the plurality of beams, to be larger than a light quantity of a beam adjacent to the rear-end beam.
